(19) United States
(12) Patent Application Publication
(10) Pub. No.: US 2015/0378804 A1
(43) Pub. Date: Dec. 31, 2015

(54) DIGITAL CINEMA PACKAGE TEST

(71) Applicant: THOMSON LICENSING, Issy de Moulineaux (FR)

(72) Inventor: Jean-Sebastien Betsch, North Hollywood, CA (US)

(21) Appl. No.: 14/704,290

(22) Filed: May 5, 2015

Related U.S. Application Data
(60) Provisional application No. 62/000,595, filed on May 20, 2014.

(51) Int. Cl. G06F 11/07

(52) U.S. Cl. CPC G06F 11/079; G06F 11/0751

(57) ABSTRACT

A method for testing a digital cinema package (DCP) having a subset of files in a particular format commences by checking the DCP to determine whether files in at least the subset are present. If so, then, the files in the subset are validated to determine whether that such files satisfy a set of prescribed rules.

### TECHNICAL FIELD

This invention relates to a technique for testing digital cinema content

### BACKGROUND ART

An increasing number of movie theaters now exhibit movies in digital form, having switched from exhibiting celluloid film. Motion picture studios prefer to distribute content in digital form because of reduced cost and overhead. Presently, the digital content delivered to movie theaters takes the form of Digital Cinema Packages (DCPs), each comprising a collection of files that include one or more feature presentations, trailers, advertisements and announcements. The Digital Cinema Initiative LLC. (DCI), a joint venture formed by major motion picture studios, has established a specification for such DCPs. The Digital Cinema Package standard established by the DCI mandates the following file components in a DCP:
Picture Files (MXF format)
Sound Files (MXF Format)
An Asset Map File (XML Format)
Composition Playlist File (XML Format)
Packing List File (XML format)
Volume Index File (XML Format)
   The picture files contain digital images of the feature presentation(s) trailer(s) announcement(s) and/or advertisements in the DCP. The picture files can exist in different formats, such as JPEG and MPEG-2 at different frame rates. The sound files contain digital audio in an MXF format corresponding to the digital images in the picture files. A given picture file could have more than one corresponding sound file. For example, the different sound files corresponding to a picture file comprise audio in different languages. The Asset Map File typically has an XML format and comprises a list of all the files in a DCP. The Composition Playlist (CPL) typically has an XML format and comprises a file that defines the playback order of picture and sound files identified by unique identifiers (UUIDs). The Packing list file typically has an XML format and comprises the hash obtained by hashing the files in the DCP to enable verification of proper receipt (ingestion) of the DCP at the movie theater. The Volume index file typically has an XML format and provides a mechanism for identifying different parts of the DCP carried by different storage mechanisms, usually hard disk drives.

Most motion picture studios contract the creation and distribution of DCPs to content mastering facilities, such as Technicolor, Hollywood Calif. Such content mastering facilities undertake rigorous testing of the DCPs they create prior to distribution. However, during distribution, DCPs can become corrupted. Currently field testing of DCPs remains limited. Unlike a celluloid film whose defects become readily apparent upon physical inspection, defects in a DCP stored on one or more hard disk drives do not become apparent on simple physical inspection of the storage media. Presently, playback servers at the movie theater will test DCPs as ingested but the test is geared towards the specific make and model of the server and provides little feedback to what is wrong with the DCP. No method currently exists for DCP testing in the field that ensures playback on legacy servers and projectors.

Thus, a need exists for a technique for field-testing DCPs that overcomes the foregoing disadvantages.

### BRIEF SUMMARY

Briefly, in accordance with an aspect of the present principles, a method for testing a digital cinema package (DCP) having a subset of files in a particular format commences by checking the DCP to determine whether files in at least the subset are present. If so, then, the files in the subset are validated to determine whether such files satisfy a set of prescribed rules.

### BRIEF DESCRIPTION OF THE DRAWINGS

FIG. 1 depicts a block diagram of a mobile digital cinema package test station in a digital cinema exhibition environment for testing digital cinema packages in accordance with an embodiment of the present principles;

FIG. 2 depicts a block schematic diagram of the mobile digital cinema package test station of FIG. 1 in accordance with an embodiment of the present principles; and

FIG. 3 depicts in flow chart form the steps of a method executed by the mobile digital cinema package test station of FIG. 2 to test digital cinema packages in accordance with an embodiment of the present principles.

### DETAILED DESCRIPTION

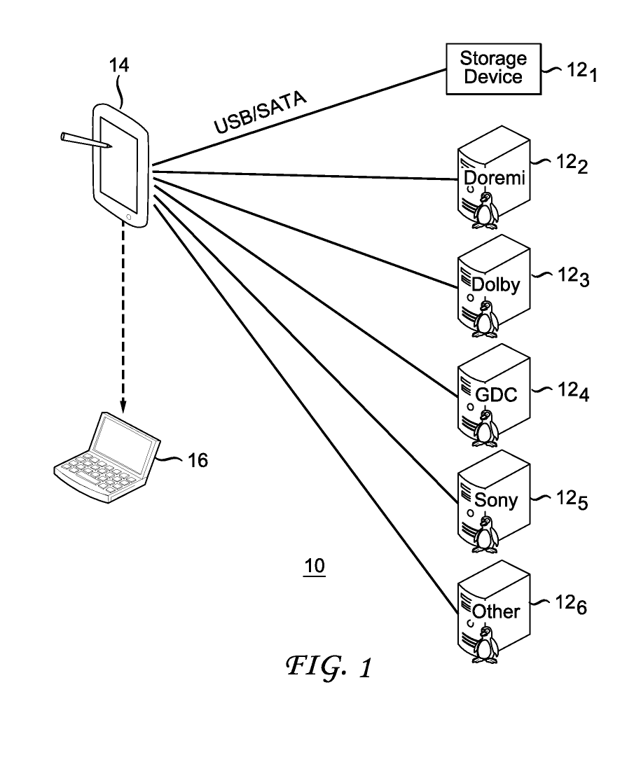

Referring to FIG. 1, in a typical digital cinema exhibition environment 10 (e.g., a movie theater), content for exhibition arrives in the form of one of more Digital Cinema Packages (DCPs) stored on one or more storage devices, illustratively depicted by storage devices 12₁-12₆. In the illustrative embodiment of FIG. 1, the storage device 12₁ comprises a RAID array, such as manufactured by CRU Acquisition Group, Vancouver Wash. The storage devices 12₂-12₅ illustratively comprise digital cinema servers manufactured by Doremi Labs, Burbank, Calif., Dolby Laboratories, Inc., San Francisco, Calif., GDC Technology, Hong Kong, and Sony, Los Angeles, Calif. The storage device 12₆ can comprises a digital cinema server from another manufacturer.

Each DCP stored on one or more of the storage devices 12₁-12₆ comprises a set of digital files and typically includes:
Picture Files (MXF format)
Sound Files (MXF Format)
An Asset Map File (XML Format)
Composition Playlist File (XML Format
Packing List File (XML format)
Volume Index File (XML Format)
   The absence and/or corruption of any of these files can adversely affect playout of a digital cinema composition (e.g., a digital cinema movie).

Replicators of DCPs, such as Technicolor, Hollywood, Calif., test DCPs during the mastering process. However, DCPs can and do become corrupted during transmission to a movie theater and subsequent storage, such as on one or more of the storage devices 12₁-12₆. To date, no mechanism has existed for field-testing DCPs.

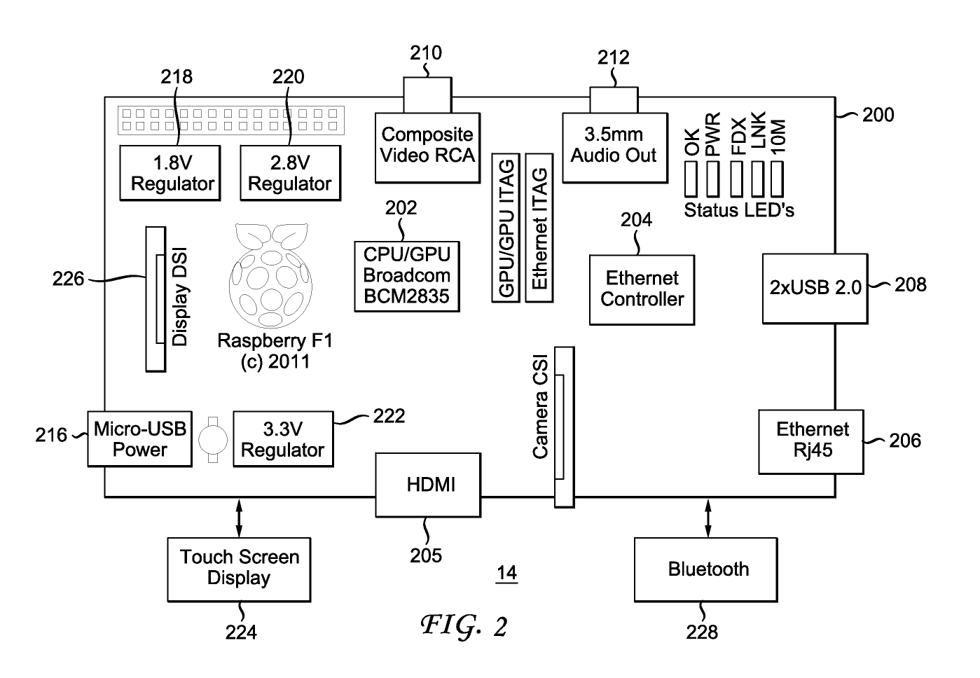

Field-testing of DCPs advantageously can occur in accordance with the present principles by using a mobile digital cinema package test station 14 described in detail with respect to FIG. 2. As will become better understood hereinafter, the mobile digital cinema package test station 14 has the capability to connect to one or more of the storage devices 12₁-12₆ to access the DCP(s) stored on such devices and test the DCPs. The mobile digital cinema package test station 14 can communicate the results of such testing to other devices, such as for examine a laptop computer 16.

FIG. 2 depicts a block schematic diagram of the mobile digital cinema package test station 14. In practice, the mobile digital cinema package test station 14 comprises a single-board microcomputer 200, such as the Raspberry PI single board microcomputer designed by the Raspberry Pi Foundation, Cambridge, Great Britain. The exemplary single-board microcomputer 200 depicted in FIG. 2 includes a central processing unit/graphical processing unit (CPU/GPU) chip 202, such as the BCM2835 CPU/GPU manufactured by Broadcom Corporation, Irvine Calif. In addition to the CPU/GPU 202, the single-board microcomputer 200 can include on-board memory (not shown) connected to the CPU/GPU chip as well as one or more sockets (not shown) for accepting memory cards, e.g., SD cards, for access by the CPU/GPU chip. Such memory

The CPU/GPU 202 interfaces with an Ethernet Controller chip 204 to allow the CPU/GPU to connect to an Ethernet network (not shown) via an RJ-45 Ethernet Port 206. An HDMI chip 205 connects to the CPU/GPU chip 202 to enable the CPU/GPU chip to interface to a HDMI device (not shown). The CPU/GPU 202 also connects to a set of ports, including a pair of USB ports 208, a video port 212 and an audio port 214. In this way, the CPU/GPU chip 202 can exchange USB signals, as well as output video and audio signals. The single-board microcomputer 200 receives power through a power port 216. A set of regulators 218, 220 and 222 serve to provide regulated power at 1.8 volts, 2.8 volts and 3.3 volts, respectively.

The mobile digital cinema package test station 14 of FIG. 2 also includes a display 224, typically a touch screen display, coupled to the single-board microcomputer 200 through a display interface connector 226 on the board. The touch screen display 224 enables an operator to enter commands and data into the single-board microcomputer 200 and to observe information displayed by the single-board microcomputer in response to such commands and data. Further, the mobile digital cinema package test station 14 of FIG. 2 also includes a Bluetooth communication circuit 226 coupled to the single-board microcomputer 200 to enable the mobile digital cinema package test station with other devices, such as the laptop computer 16 of FIG. 1.

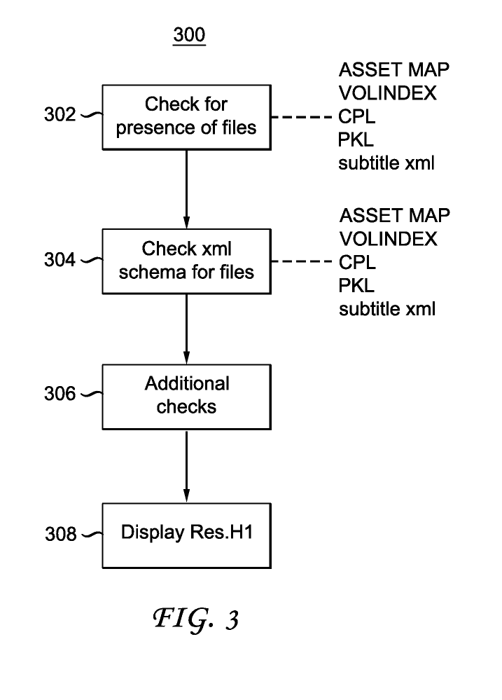

FIG. 3 depicts in flow chart form the steps of a method 300 executed by the single-board microcomputer 200 of the digital cinema package test station 14 to test a DCP. The method 300 of FIG. commences by checking for the presence of a sub-set of files, typically the files in XML form, including the Asset Map File, the Composition Playlist File, the Packing List File, and the Volume Index File, as well as a subtitle file, which can also appear in a DCP. If one or more of these files are missing, then the DCP current under test is most likely corrupt.

A DCP with the Asset Map File, the Composition Playlist File, the Packing List File, and the Volume Index File, and the subtitle files present could still be corrupt if the XML schema of any of such files is improper. Thus, following step 302, a check of the XML schema of the XML-format files occurs during step 304. In practice, the XML schema of an XML-formal file is expressed in terms of syntactical constraints expressed by a combination of grammatical rules. Thus, checking of the XML schema during step 304 entails checking whether the files satisfy a prescribed set of rules, typically grammatical rules governing the order of elements, Boolean predicates that the content must satisfy and rules defining proper data types

While checking for the presence of files during step 302 and checking the XML file schema during step 304 provide a good mechanism testing a DCP, performing one or more additional tests during step 306 can prove valuable to ensure playback on legacy servers and projectors although such tests are not essential to the present principles. Such additional checks can include (but are not limited to)

Tests for unreferenced assets in DCP

Tests the validity of the common name of the certificate signer

Removes illegal signature form CPL/PKL if needed

Tests for spaces in files names and Content Title

Test presence of ttf font

Checks size of ttf font is <640 KB

Test for illegal characters in xml language code

Further, an additional test performed during step 306 could include hashing the files in the DCP and comparing the value to the hash contained in the packing list file. Checking the hash value of the file and comparing with the value stored in the PKL, while useful would require a more powerful processor than the Raspberry Pi single board computer, which in the preferred embodiment comprises the microcomputer 200. After the tests performed during steps 302, 304 and 306, the results undergo display during step 308.

The foregoing describes a technique for testing a digital cinema package.

1. A method for testing a digital cinema package (DCP) received from a content mastering facility, the DCP including a subset of files having a particular format, comprising,
checking the DCP to determine whether all files in the subset are present and
validating those files in the subset to determine whether such files satisfy a set of prescribed rules.

2. The method according to claim 1 further including the steps of displaying a results after checking the DCP and validating files.

3. The method according to claim 1 wherein the prescribed rules include grammatical rules governing file element order.

4. The method according to claim 1 further including performing another test on the DCP package.

5. The method according to claim 4 wherein the additional test includes:
hashing the files in the DCP to yield a hash value; and
comparing the hash value to a reference value, and
validating the DCP when the hash value matches the reference value.

6. The method according to claim 4 wherein the additional test includes at least one of the following:
Testing for unreferenced assets in the DCP;
Testing validity of a common name of a certificate signer;
Removing an illegal signature form in CPL/PKL file;
Testing for spaces in files names and a Content Title;
Testing for presence of a ttf font;
Checking a size of ttf font is <640 KB; and
Testing for illegal characters in xml language code.

7. A mobile digital cinema package test station for testing a digital cinema package (DCP) received from a content mastering facility, the DCP including a subset of files having a particular format, comprising,
a processor for (a) checking the DCP to determine whether all files in the subset are present and (b) validating those files in the subset to determine whether that such files satisfy a set of prescribed rules;
a data entry and display device for enabling an operator to enter commands and data into the process and to observe information displayed processor in response to such commands and data; and
a communication circuit coupled to processor to enable the processor to communicate with other devices.

8. The mobile digital cinema package test station according to claim 7 wherein the processor generates display information representing results after checking the DCP and validating files.

9. The mobile digital cinema package test station according to claim 8 wherein the prescribed rules include grammatical rules governing file element order.

10. The mobile digital cinema package test station according to claim 7 wherein the processor performs another test on the DCP package.

11. The mobile digital cinema package test station according to claim 10 wherein the processor performs an additional test on the DCP by hashing the files in the DCP to yield a hash value; comparing the hash value to a reference value, and validating the DCP when the hash value matches the reference value.

12. The mobile digital cinema package test station according to claim 10 wherein the processor performs an additional test on the DCP, which includes at least one of the following:
Testing for unreferenced assets in the DCP;
Testing validity of a common name of a certificate signer;
Removing an illegal signature form in CPL/PKL file;
Testing for spaces in files names and a Content Title;
Testing for presence of a ttf font;
Checking a size of ttf font is <640 KB; and
Testing for illegal characters in xml language code.

13. The mobile digital cinema package test station according to claim 7 wherein the data entry and display device comprises a touch screen display.

14. The mobile digital cinema package test station according to claim 7 wherein the communications circuit comprises a Bluetooth communications circuit.
